(19) United States
(12) Patent Application Publication
(10) Pub. No.: US 2006/0143502 A1
(43) Pub. Date: Jun. 29, 2006

(54) System and method for managing failures in a redundant memory subsystem

(75) Inventors: Rohit Chawla, Waco, TX (US); Farzad Khosrowpour, Pflugerville, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/009,175

(22) Filed: Dec. 10, 2004

(51) Int. Cl. G06F 11/00

(52) U.S. Cl. 714/6

(57) ABSTRACT

A network and a method for network operation are disclosed that facilitates the identification of a failure in the storage subsystem of the network and the recovery from such a failure. The storage subsystem includes storage enclosures that are coupled to each of the server nodes of the network. When a server node determines that it can no longer access a drive of the storage enclosure, the server node notifies the alternate server node of the network, which attempts to access the drive. If the alternate server node of the network can access the drive, the ownership of the logical unit that includes the drive is transferred to the alternate server node.

### TECHNICAL FIELD

The present disclosure relates generally to computer networks, and, more particularly, to a system and method for managing failures in a redundant subsystems.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

The architecture of a computer system may include a storage subsystem that is commonly accessible by multiple server nodes of the network. The storage subsystem of the computer network may include fault tolerant storage, such as a RAID array, and the elements of the fault tolerant storage array may be spread over multiple storage enclosures of the storage subsystem. One difficulty of such a network architecture is determining if the source of a failure is the drive of a fault tolerant storage array of the storage enclosure. In some cases, the failure of a communications link between (a) a controller and a storage enclosure or (b) two storage enclosures may be incorrectly recognized as the failure of a drive array. In other cases, the failure of an expansion port in a storage enclosure may be incorrectly recognized as the failure of a drive array. If the failure point in the storage subsystem is not correctly identified, the correct failover technique may not be employed.

### SUMMARY

In accordance with the present disclosure, a network and a method for network operation is disclosed that facilitates the identification of a failure in the storage subsystem of the network and the recovery from such a failure. The storage subsystem disclosed herein includes at least one or more storage enclosures that are coupled to each of the server nodes of the network. When a server node determines that it can no longer access a drive of the storage enclosure, the server node notifies the alternate server node of the network, which attempts to access the drive. If the alternate server node of the network can access the drive, the ownership of the logical unit that includes the drive is transferred to the alternate server node.

The system and method disclosed herein is technically advantageous because it provides a technique for transferring ownership of a logical unit to an alternate server node following the identification of a failure in a communications link or port of the storage subsystem. In the event of a failure of a communications link or a port in the communications path of a server node, ownership of the logical unit of the server node can be transitioned to an alternate node.

The system and method disclosed herein is also advantageous in that it provides a technique in which a failure of a communications link or port in the storage subsystem can be distinguished from a failure of a drive of the storage subsystem. If a server node cannot access a drive, and if an alternate server node can access the same drive, then the drive itself is not the cause of the failure of the server node to communicate with the drive. The logical unit that includes the drive is transferred to the alternate node and is not identified as having failed. Thus, the technique disclosed herein provides a technique for distinguishing between drive failures and other failures. The system and method disclosed herein provides an alternative for marking a drive as having failed when the cause of the inaccessibility is not the drive. Thus, the technique disclosed herein eliminates the practice of marking an otherwise good drive as having failed. Because good drives are not marked as failed in this circumstance, the loss of data or the degraded performance of the affected logical unit does not occur. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a computer network; and

FIG. 2 is a flow diagram of a method for recognizing the inability to access a drive of a storage enclosure and determining whether ownership of the logical unit should be passed to an alternate storage controller of the storage network.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

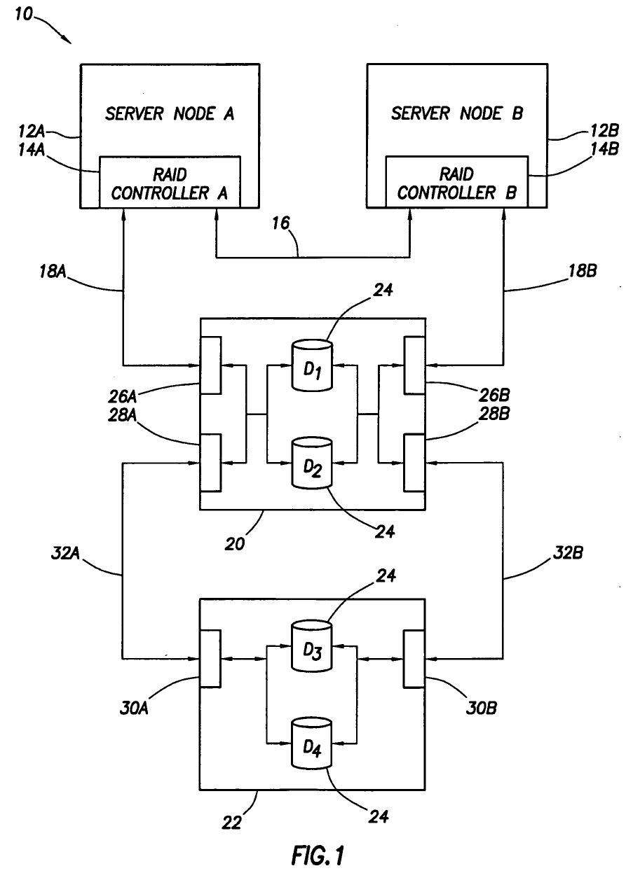

Shown in FIG. 1 is a network, which is indicated generally at 10. Network 10 includes two server nodes, which are identified as server node A at 12A, and server node B at 12B. Each server node 12 includes a RAID controller 14, which may be included in each server node as a card that is included in a PCI (Peripheral Component Interconnect) slot of the server. Each RAID controller 14 is operable to manage the access to drives in the storage enclosures 20 and 22 of the network 10. Each RAID controller is coupled through a communications link to a primary storage enclosure 20. RAID Controller A is coupled through communications link 18A to a port 26A of primary storage enclosure 20, and RAID Controller B is coupled through communications link 18B to a port 26B of primary storage enclosure 20.

In the example of FIG. 1, storage enclosure 20 includes ports 26A and 26B, which are coupled, respectively, to server node A and server node B. With respect to the server nodes of the network, ports 26 serve as input ports and output ports for storage enclosure 20. Port 26A is coupled to an expansion port 28A, and port 26B is coupled to an expansion port 26B. Port 28 is referred to as an expansion port because it provides an expansion communications link to storage enclosure 22. Each port of the enclosure 20, whether the port is an input/output port 24 or an expansion port 28, is coupled to two storage drives 24, which are labeled D₁ and D₂. Each of drives D₁ and D₂ can be accessed by either server node A, through communications link 18A and port 26A, or server node B, through communications link 18B and port 26B.

A storage enclosure 22 is coupled to storage enclosure 20 through an expansion communications link 32. Port 28A of storage enclosure 20 is coupled to an input/output port 30A of storage enclosure 22 through an expansion communications link 32A, and port 28B of storage enclosure 20 is coupled to an input/output port 30B of storage enclosure 22 through an expansion communications link 32B. Expansion storage enclosure 22 includes a pair of storage drives, which are labeled D₃ and D₄, and which are each coupled to port 30A and port 30B. Each server node 12 can access each of the storage drives of expansion storage enclosure 22. Server node B can access storage drive D3, for example, through communications link 18B, ports 26B and 28B of storage enclosure 20, and port 30B of storage enclosure 22. Likewise, server node A can access the storage drives of the expansion storage enclosure 22 through communications link 18A, ports 26A and 28A of storage enclosure 20, and port 30A of storage enclosure 22. The four storage drives shown in the example of FIG. 1 can comprise a single RAID array, which can be managed and logically owned as a single logical unit by RAID controller A of server node 12A or RAID controller B of server node 12B. In this architecture, the storage drives of the RAID array are distributed across two storage enclosures.

The server nodes of network 10 may communicate with one another through a peer communications link 16 coupled between the RAID controllers of the respective server nodes. Server nodes 12 may transmit data over peer communications link 16 concerning the operational status of each server node or any logical storage owned by each server node. In operation, a server node that owns a storage drive on one of the enclosures of the storage network periodically accesses the storage drive. In this example, assume that server node B owns a logical unit that comprises the two storage drives of storage enclosure 20 and the two storage drives of storage enclosure 22 organized as a RAID array. If server node B cannot communicate with one of the drives of the array, server node B will notify server node A of the inability to communicate with the drive. In this example, if server node B cannot communicate with drive D₃, server node B will notify server node A that server node B is not able to communicate with drive D₃.

Following the receipt of an access failure from a peer node the node receiving the notification will attempt to access the drive at issue. In this example, server node A will attempt to access drive D₃. If server node A can access drive D3, the drive is not the point of a communications failure between server node B the drives of the expansion storage enclosure 22. After it is determined that the alternate or failover drive can access the drive at issue, the logical ownership over the entire logical unit is transferred to the alternate drive. In the present example, once it is determined that server node A can access drive D3, the entire logical unit that includes drive D3 is transitioned to server node A. Server node A becomes the logical owner of each of the drives of the logical unit, which, in the present example, are the two drives of storage enclosure 20 and the two drives of storage enclosure 22. If the alternate server node also cannot access the drive at issue, the drive may be the source of failure between the primary server node and the non-responsive drive. In this case, the entire logical unit is designated as being offline so that the failed drive or drives of the array can be rebuilt.

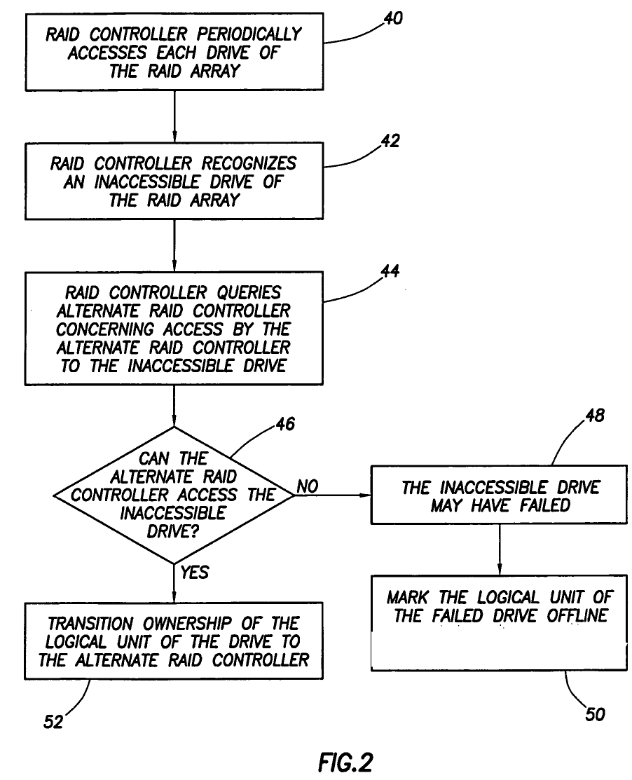

Shown in FIG. 2 is a flow diagram of a method for recognizing the inability to access a drive of a storage enclosure and determining whether ownership of the logical unit should be passed to an alternate storage controller of the storage network. At step 40, the RAID controller that owns a logical unit of storage drives periodically accesses each storage drive of the logical unit. For the sake of this description, the RAID controller that first owns the logical unit will be referred to as the first RAID controller. At some point, as indicated by step 42, the RAID controller may recognize that it is unable to access a drive of the logical unit. The inability to access a drive of the logical unit may be due to a failure of a communications link, a port, a storage enclosure, or the storage drive itself. At step 44, the RAID controller notifies the alternate RAID controller that the first RAID controller is unable to access a drive of a logical unit owned by the first RAID controller. The notification to the alternate RAID controller will include an identification of the inaccessible drive. In this circumstance, the inaccessible drive must be one that can be accessed by the alternate RAID controller, even if the inaccessible drive is presently owned by the alternate RAID controller.

At step 46, the alternate RAID controller determines if it can access the inaccessible drive identified by the first RAID controller. If the inaccessible drive cannot be accessed by the first RAID controller, the inaccessible drive may be a point of failure, as indicated at step 48. If the alternate RAID controller is not able to access the inaccessible drive, it is also possible that the storage enclosure that houses the inaccessible drive may have failed. At step 50, the logical unit that includes the inaccessible drive is marked offline. If the RAID array of the inaccessible drive is a non-redundant RAID array, such as a RAID Level 0 array, the user will not have access to the logical unit that includes the inaccessible drive. If the RAID array of the inaccessible drive is a redundant RAID array, a rebuild is initiated to rebuild the data of the inaccessible drive. If it is determined at step 46 that the alternate RAID controller can access the drive, then it is established that the storage enclosure or the drive itself is not the point of failure between the first RAID controller and the drive. The alternate RAID controller in this circumstance can access the drive through an alternate set of communication links and ports. Rather, the point of failure between the first RAID controller and the drive is likely one of the communication links between the first RAID controller and the drive, or one of the ports between the first RAID controller and the drive. At step 52, following the determination that the alternate RAID controller can access the drive, the ownership of the logical unit that includes the drives is transitioned from the first RAID controller to the alternate RAID controller. Following the ownership transition, each of the drives of the RAID array is accessible through the alternate RAID controller.

The network architecture and methodology disclosed herein provides a technique for avoiding the circumstance in which an entire RAID array is taken offline or degraded at a time when the individual drives of the drive array are not the point of failure for the drive array. The drive array can be transitioned to another RAID controller and the drives of the drive array can remain operational during this period, thereby avoiding the condition in which the drives of the array are operational, but the drives are nevertheless marked offline as a result of an undiagnosed failure in the communications link or port between the first RAID controller and the drive. Because the operational logical unit can be transitioned to an alternate RAID controller in this circumstance, user access to the content of the drives of the logical unit is not interrupted for an appreciable period of time.

It should be understood that the methodology disclosed herein for recognizing communication failures in a storage subsystem and transitioning ownership of a RAID array to another RAID controller is not limited to the precise network architecture disclosed herein. Rather, the methodology may be employed in other network architectures that involve multiple storage enclosures, multiple server nodes, and multiple RAID controllers. Each RAID controller, for example, may have multiple alternate RAID controllers. Although the present disclosure has been described in detail, it should be understood that various changes, substitutions, and alterations can be made hereto without departing from the spirit and the scope of the invention as defined by the appended claims.

What is claimed is:

1. A network, comprising:
first and second server nodes, wherein each server nodes include a storage controller for the management of fault tolerant data storage within the network;
a peer communications link coupled between the first server node and the second server node;
a first storage enclosure, comprising:
a first port coupled to the first server node;
a second port coupled to the second server node;
at least one storage drive;
a second storage enclosure, comprising:
a first port coupled to the first storage enclosure;
a second port coupled to the first storage enclosure;
at least one storage drive;
wherein the storage drives of the first storage enclosure and the second storage enclosure may be accessed through the first server node or the second server node;
wherein each of the first and second server nodes is operable to notify the other server node of an inability to access a storage drive of the first or second storage enclosures, and to transition logical ownership of said storage to the other server node if the other server node is able to access the storage drive.

2. The network of claim 1,
wherein the first port of the second storage enclosure is coupled to a third port of the first storage enclosure; and
wherein the second port of the second storage enclosure is coupled to a fourth port of the first storage enclosure.

3. The network of claim 1,
wherein the first port of the second storage enclosure is coupled to a third port of the first storage enclosure;
wherein the second port of the second storage enclosure is coupled to a fourth port of the first storage enclosure;
wherein the first port of the first storage enclosure is coupled to the third port of the first storage enclosure; and
wherein the second port of the first storage enclosure is coupled to the fourth

4. The network of claim 1, wherein an array of storage drives comprising at least one storage drive from the first storage enclosure and one storage drive from the second storage enclosure comprise a single fault tolerant data storage array that is operable to be controlled by a storage controller of the first server node or the second server node.

5. The network of claim 4, wherein the array of storage drives comprise a RAID array.

6. The network of claim 4, wherein the RAID array comprises multiple storage drives from the first storage enclosure and multiple storage drives from the second storage enclosure.

7. The network of claim 1,
wherein the first port of the second storage enclosure is coupled to a third port of the first storage enclosure;
wherein the second port of the second storage enclosure is coupled to a fourth port of the first storage enclosure;
wherein an array of storage drives comprising multiple storage drives from the first storage enclosure and multiple storage drives from the second storage enclosure comprise a RAID array that is operable to be controlled by a storage controller of the first server node or the second server node.

8. A method for responding to a drive failure in a storage subsystem of a network having multiple server nodes, comprising:
identifying an inaccessible drive in a storage subsystem, wherein the inaccessible drive comprises a drive of a logical storage unit that includes multiple drives, and wherein the inaccessible drive is identified by the server node that is the logical owner of the logical storage unit;
transmitting a notification from the server node that owns the logical storage unit of the inaccessible drive to an alternate server node of the network, wherein the alternate server node is operable to access the inaccessible drive but is not the present owner of the logical storage unit that includes the inaccessible drive;
attempting to access the inaccessible drive from the alternate server node; and
if it is determined that the inaccessible drive can be accessed by the alternate server node, transferring ownership of the logical storage unit that includes the server drive to the alternate server node.

9. The method for responding to a drive failure in a storage subsystem of a network having multiple server nodes of claim 8, wherein the logical storage unit of the memory subsystem comprises at least one drive in a first storage enclosure of the memory subsystem and at least one drive in a second storage enclosure of the memory subsystem.

10. The method for responding to a drive failure in a storage subsystem of a network having multiple server nodes of claim 8, wherein the logical storage unit of the memory subsystem comprises a fault tolerant array of drives, wherein at least one drive of the array is within a first storage enclosure of the memory subsystem and wherein at least one drive of the array is in a second storage enclosure of the memory subsystem.

11. The method for responding to a drive failure in a storage subsystem of a network having multiple server nodes of claim 10, wherein the fault tolerant array is a RAID array.

12. The method for responding to a drive failure in a storage subsystem of a network having multiple server nodes of claim 11, wherein the fault tolerant RAID array includes multiple drives in the first storage enclosure and multiple drives in the second storage enclosure.

13. The method for responding to a drive failure in a storage subsystem of a network having multiple server nodes of claim 8, further comprising the step of:
if it is determined that the inaccessible drive cannot be accessed by the server node, designating the logical unit that includes the server node as being offline.

14. The method for responding to a drive failure in a storage subsystem of a network having multiple server nodes of claim 8, wherein storage subsystem comprises,
a first storage enclosure coupled to each of the server nodes of the network;
a second storage enclosure coupled to first storage enclosure of the network;
whereby each drive of the first storage enclosure and each of the second storage enclosure may be accessed by each of the server nodes of the network.

15. The method for responding to a drive failure in a storage subsystem of a network having multiple server nodes of claim 14, wherein the communication path between the storage enclosures and the first server node is separate from the path between the second storage enclosures and the second server node.

16. A method for managing component failures in a network having a shared storage resource coupled to a first server node and to a second server, wherein the shared storage resource includes a logical unit that is initially owned by the first server node, comprising:
determining at the first server node that the first server node is unable access a first drive of the shared storage resource;
notifying the second server node that the first server node is unable to access a drive of the first storage resource;
determining if the second server node is able to access the first drive of the shared storage resource; and
if the second server node is able to access the first drive of the shared storage resource, transitioning ownership of the shared storage resource from the first server node to the second server node.

17. The method for managing component failures in a network of claim 16, further comprising the step of:
if the second server node is unable to access the first drive of the shared storage resource, identifying the logical unit as being offline.

18. The method for managing component failures in a network of claim 16, wherein the shared storage resource comprises:
a first storage enclosure coupled to each of the first server node and the second server node; and
a second storage enclosure coupled to the first storage enclosure;
wherein the communication path between the storage enclosures and the first server node is separate from the communication path between the storage enclosures and the second server node.

19. The method for managing component failures in a network of claim 18, wherein the logical unit comprises a fault tolerant data storage array that includes at least one drive on the first storage enclosure and at least one drive on the second storage enclosure.

20. The method for managing component failures in a network of claim 19, wherein the fault tolerant data storage array is a RAID array.
